(19) United States
(12) Patent Application Publication
(10) Pub. No.: US 2023/0274366 A1
(43) Pub. Date: Aug. 31, 2023

(54) SYSTEM AND METHOD FOR GENERATING LEGITIMACY REPORTS AND CUSTOMIZING POLICIES

(71) Applicant: Dionda M. Gatling, St. Louis, MO (US)

(72) Inventor: Dionda M. Gatling, St. Louis, MO (US)

(21) Appl. No.: 18/109,105

(22) Filed: Feb. 13, 2023

Related U.S. Application Data
(63) Continuation of application No. 15/718,992, filed on Sep. 28, 2017, now abandoned.

(51) Int. Cl. G06Q 40/08; G06F 16/245; G06F 16/248

(52) U.S. Cl. CPC G06Q 40/08; G06F 16/245; G06F 16/248

(57) ABSTRACT

A computer verification system for generating legitimacy reports and customizing policies includes at least one processor coupled to a memory. The memory is configured to store instructions that, when executed by the at least one processor, cause the at least one processor to receive a user-defined life insurance search request, generate search results from a plurality of providers based on the search request, generate a legitimacy report for each provider, display the policy search results and associated legitimacy reports, generate a menu of options for each policy, and process a user-selected option from the menu of options. The menu includes at least one of viewing the policy, modifying at least one parameter of the policy, and generating a claim for benefits from the policy.

### CROSS-REFERENCE TO RELATED APPLICATION

This application is a continuation of U.S. patent application Ser. No. 15/718,992, filed Sep. 28, 2017, the entire contents of which are incorporated by reference.

### BACKGROUND

The field of the disclosure relates generally to systems for generating legitimacy reports and customizing policies, and, more specifically, to a computer system including a searchable database of policies that provides reports on providers of the policies and enables users to retrieve and customize the policies.

Known systems often require information such as a life insurance policy number or the specific name of a particular insurance carrier to conduct a search for life insurance policies. However, such information may not be available to the searcher. For example, the searcher may not have access to or even knowledge of information pertaining to a relevant life insurance policy. In addition, the systems may include information about the insurance policies that is inaccurate, illegitimate, and/or not validated. Accordingly, a searcher may be unable to locate relevant life insurance policies using known systems.

Therefore, a system is needed that includes a database of life insurance policies and allows for a search of the life insurance policies using readily available information.

### BRIEF DESCRIPTION

In one aspect, a system for managing life insurance policies includes a database including a plurality of life insurance policies. The life insurance policies are provided by a plurality of life insurance providers. The system also includes a user interface configured to receive a user-defined search request. The system further includes a processor configured to generate search results from the database based on the search request, and generate a legitimacy report for at least one of the life insurance providers. The system also includes a display device configured to display the search results and the legitimacy report. The legitimacy report is associated with the search results.

In another aspect, a method for managing life insurance policies includes providing a database including a plurality of life insurance policies. The life insurance policies are provided by a plurality of life insurance providers. The method also includes receiving, by a computer system, a user-defined search request and generating search results from the database based on the search request. The method further includes generating, by the computer system, a legitimacy report for at least one of the life insurance providers. The method also includes displaying, at a display device, the search results and the legitimacy report. The legitimacy report is associated with the search results.

In yet another aspect, an article of manufacture including a non-transitory, tangible, computer readable storage medium having instructions stored thereon is provided. Execution of the instructions by at least one processor causes the at least one processor to receive a user-defined search request for a plurality of life insurance policies stored on a database. The life insurance policies are provided by a plurality of life insurance providers. The instructions also cause the at least one processor to generate search results from the database based on the search request. The search results are displayed on a display device. The instructions also cause the at least one processor to generate a legitimacy report for at least one of the life insurance providers. The legitimacy report is associated with the search results.

### BRIEF DESCRIPTION OF THE DRAWINGS

FIG. 1 is a block diagram of an exemplary computer system including a database of life insurance policies.

FIGS. 2A and 2B show a flow diagram of an exemplary method of operating a computer system for managing life insurance policies, such as the computer system shown in FIG. 1.

### DETAILED DESCRIPTION

As used herein, an element or step recited in the singular and preceded with the word “a” or “an” should be understood as not excluding plural elements or steps, unless such exclusion is explicitly recited. Furthermore, references to “example implementation” or “one implementation” of the present disclosure are not intended to be interpreted as excluding the existence of additional implementations that also incorporate the recited features.

As used herein, the term “non-transitory computer-readable media” is intended to be representative of any tangible computer-based device implemented in any method of technology for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including without limitation, volatile and non-volatile media, and removable and non-removable media such as firmware, physical and virtual storage, CD-ROMS, DVDs, and any other digital source such as a network or the Internet, as well as yet to be developed digital means, with the sole exception being transitory, propagating signal.

The present disclosure provides systems and methods including a searchable database of insurance policies and legitimacy reports for providers of the insurance policies. The system allows for users to request a search for life insurance policies by using basic information of the policyholder. Accordingly, the database may be simpler to use because basic information of policyholders may be more readily available than life insurance policy numbers or the name of a particular insurance carrier.

For example, beneficiaries or other users may be able to search the database by using information such as name, social security number, death certificate number, and date of birth. Accordingly, the users may be able to locate policies of individuals that died within a period of time, such as over the past ten years. Based on the information, all relevant policies will be included in the search results. In addition, the user would be provided with a menu that would allow the user to perform functions such as notifying the insurance provider of the individual's death and initiate a claim(s) for life insurance benefits.

Further, embodiments of the present disclosure provide a system that presents a legitimacy report associated with verified insurance companies and their policies. As a result, a user of the present system may view a life insurance policy from a verified insurance provider and know that the policy they are viewing is legitimate.

Additionally, embodiments provide an incentive for insurance companies to accurately publish their life insurance policies. For example, an insurance provider must complete requirements such as providing a thorough list of their life insurance policies for the insurance provider to be labeled as legitimate within the computer system. In addition, the requirements may include allowing an examination of a company's licensing record. Companies who receive the legitimate status may be promoted to users of the system. Additionally, users may be able to see which searchable policies are from companies who have obtained legitimate status. As a result, users may have confidence that the policies they view from companies labeled as legitimate are thorough and accurate.

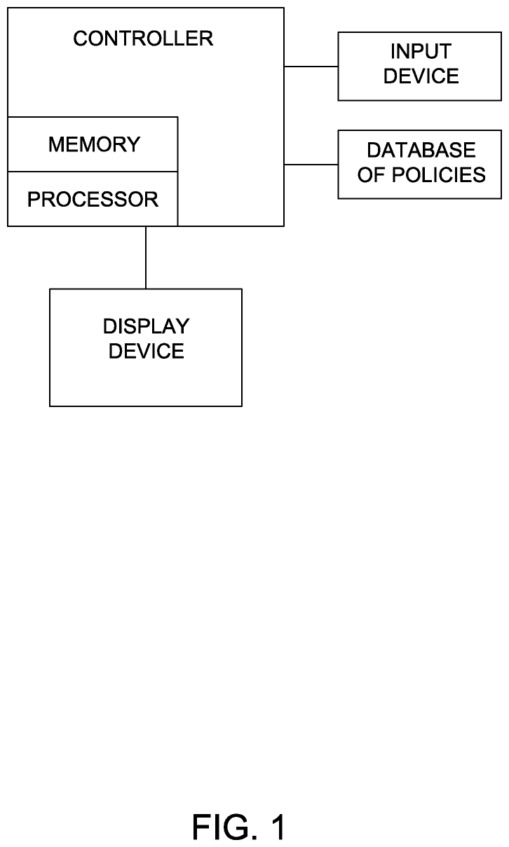

FIG. 1 is a block diagram of an exemplary computer system 100. Computer system 100 includes a controller 102, a memory 104, a processor 106, a display device 108, an input device, broadly a user interface, 110, and a database 112. Processor 106 is coupled to memory 104. In some embodiments, memory 104 is configured to store at least a portion of database 112. Database 112 includes a plurality of life insurance policies provided by a plurality of life insurance providers. In some embodiments, database 112 is at least partially stored on a remote computing system. In alternative embodiments, computer system 100 has any configuration that enables computer system 100 to operate as described.

For example, database 112 may include categories of insurance policies. Database 112 may include active insurance policies that have been assigned to people. The active insurance policies may be at least partially paid and/or may have at least some payments due. In addition, database 112 may include expired insurance policies. Also, database 112 may include standard and custom insurance policies that are offered by the providers and are available for purchase and/or viewing. The database 112 may include insurance policies for a period of time and allow users to search historical data. For example, database 112 may include insurance policies, such as unclaimed insurance policies, for a time period of up to ten years. In alternative embodiments, database 112 includes any insurance policies that enable computer system 100 to operate as described.

Computer system 100 is configured to allow a user to search life insurance policies using readily available information. In addition, computer system 100 allows a user to view and/or modify the relevant life insurance policies. For example, memory 104 is configured to store instructions for processor 106. When the instructions are executed, processor 106 receives a user-defined life insurance request from input device 110. Further, processor 106 is configured to generate search results from database 112 that includes policies from a plurality of life insurance providers. In addition, computer system 100 may be configured to associate the search results with a legitimacy report for each insurance carrier. The search results and associated legitimacy reports are displayed on display device 108. Display device 108 may include a screen and/or any other suitable display device.

In some embodiments, input device 110 includes a keyboard, a computer pointer device, a touch screen, a microphone, a camera, and/or any other suitable input device. Input device 110 may be incorporated into a computing device including controller 102 and/or display device 108. In other embodiments, input device 110 may be located remotely from controller 102 and/or incorporated into a computing device that communicates with controller 102 using a computer network. For example, in some embodiments, input device 110 is included on a mobile computing device.

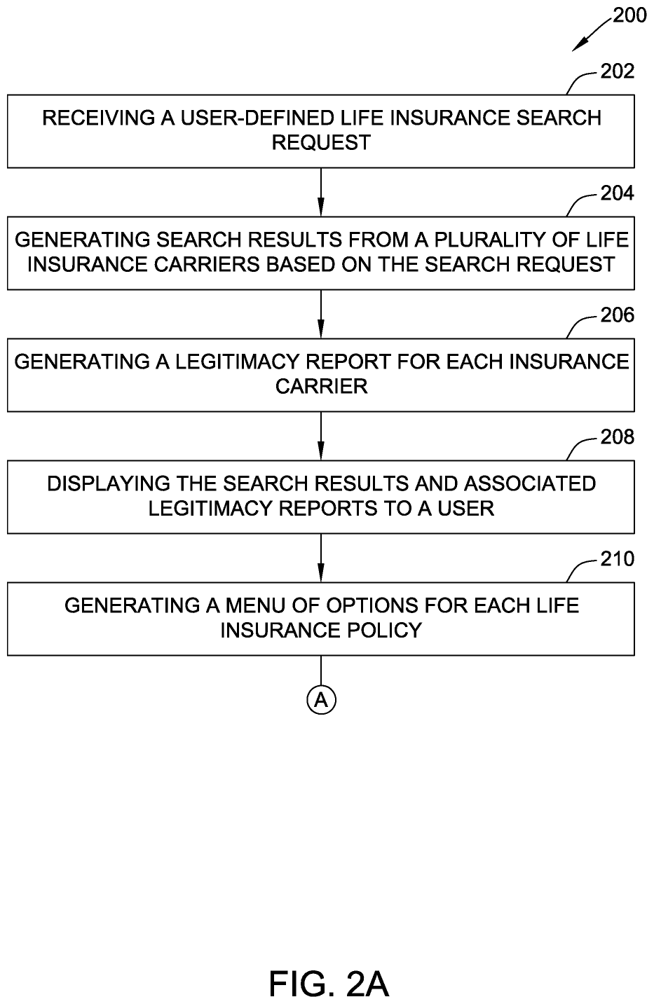

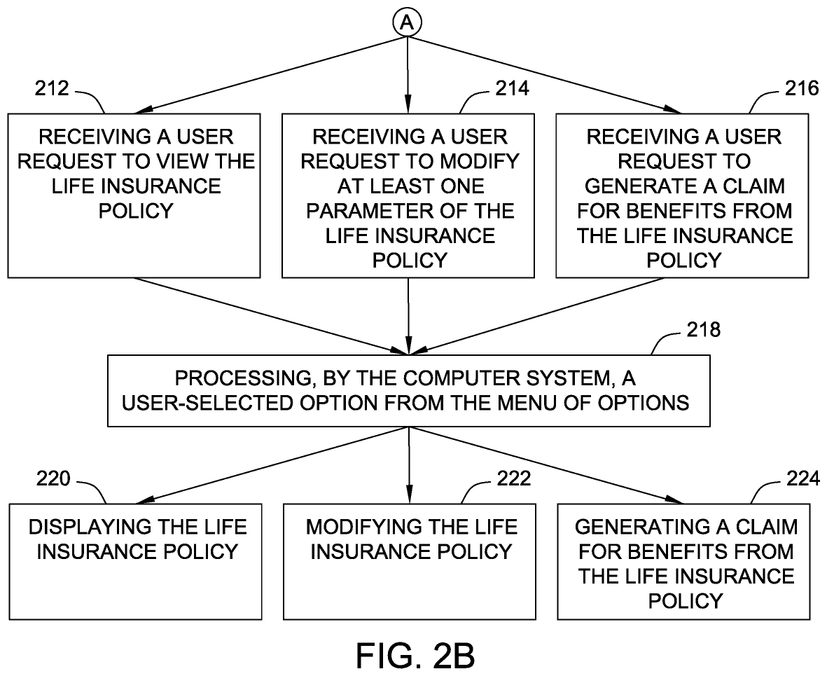

FIGS. 2A and 2B show a flow diagram of an exemplary method 200 of operating computer system 100, shown in FIG. 1. Method 200 comprises receiving 202, using processor 106, a user-defined life insurance search request from input device 110. Processor 106 generates 204 search results. The search results are generated by processor 106 from database of policies 112. The search results are based on the search request received 202 from the user. Additionally, processor 106 generates 206 a legitimacy report for each insurance carrier in database of policies 112. Computer system 100 then displays 208 the search results and one or more legitimacy reports on display device 108.

Processor 106 generates 210 a menu of options for each life insurance policy in the search results. The menu includes, for example, at least one of the following: viewing, at display device 108, at least one life insurance policy of the plurality of life insurance policies, modifying at least one parameter of the life insurance policy, and generating a claim for benefits from the life insurance policy. For example, modifying at least one parameter may include changing a date, a term, a payment schedule, a payout schedule, a payout amount, a beneficiary, a policyholder, and any other suitable parameter. In addition, modifying at least one parameter may occur when a user purchases a life insurance policy. In other embodiments, the menu may include any suitable options.

The method includes processor 106 receiving 212, 214, and 216 at least one user selected option. Receiving 212 includes receiving a user request from input device 110 to view the selected life insurance policy on display device 108. Receiving 214 includes receiving a user request from input device 110 to modify at least one parameter of the selected life insurance policy. Receiving 216 comprises receiving a user request from input device 110 to generate a claim for benefits from the selected life insurance policy. After receiving at least one request 212, 214, 216, processor 106 processes 218 the user-selected option from the menu of options generated in 210. For instance, if processor 106 receives 212 a user request to view a life insurance policy, processor 106 displays 220 said life insurance policy on display device 108. Similarly, if processor 106 receives 214 a request to modify an insurance policy, processor 106 is configured to modify 222 the life insurance policy. Additionally, if processor 106 receives 216 a request to generate a claim, processor 106 is configured to generate 224 a claim for benefits from the life insurance policy. As a result, the life insurance policy may be modified and/or viewed. In addition, computer system 100 may allow the user to perform an action relating to the life insurance policy such as filing a claim for benefits.

In some embodiments, method 200 includes receiving verification information from the user. The verification information may be used to determine that a user should be authorized to view the life insurance policies. For example, the information may include biographical data such as birthdate, age, gender, marital status, name, and/or a legal status of the policyholder and/or user. The user may be identified as a spouse, a heir, guardian, a beneficiary, and/or any other authorized person. The information may allow computer system 100 to determine if the user has a legal relationship to the policyholder and if the user should be authorized to view the policy.

In some embodiments, a legitimacy report is generated 204 for each insurance provider based on the accessibility of the life insurance policies provided by the insurance providers. For example, an insurance provider may obtain legitimate status by providing insurance policies to database 112. In addition, the legitimacy report may be based on factors such as ability to modify the life insurance policies, available options for the life insurance policy, the financial standing of the insurance provider, an accreditation of the insurance provider, a customer rating of the insurance provider, and/or the information provided by the insurance provider for each life insurance policy. In some embodiments, the legitimacy status may be a binary characterization in which each insurance provider is labeled as legitimate or illegitimate. In further embodiments, the legitimacy report may include information such as rankings, grades, descriptive information, opinions, and any other characterizing information.

Computer system 100 may allow a computer to sort the search results. For example, input device 110 may receive a user request to sort the search results based on the legitimacy status of the insurance providers, the payout status of the insurance policies, biographical data of the policyholder, a date related to the insurance policy, and/or any other suitable characteristic. Computer system 100 may include a filter to sort the search results based on the user request and/or based on an algorithm. For example, computer system 100 may position policies provided by insurance providers having a legitimate status in a priority position in the search results to highlight legitimate insurance providers. In addition, computer system 100 may highlight insurances providers such as those insurance providers that have obtained legitimate status. The insurance providers may be highlighted by priority positioning in the search results, by providing an advertisement for the insurance provider, and/or by modifying the display of the search results on display device 108.

Accordingly, embodiments of the present disclosure allow a user to search for insurance policies with readily available information and generate a request based on the search results. For example, a user may search for insurance policies of a deceased/incapacitated person related to the user. The system may verify the identity of the user and allow the user to search after the verification. The user then may identify, make modifications to, and/or file claims on insurance policies that the user may not have had previous knowledge of As a result, the number of unclaimed insurance policies may be reduced and the time and cost required to payout and/or maintain insurance policies may be reduced.

In addition, embodiments of the present disclosure provide a database including life insurance policies and legitimacy reports for the insurance providers related to the search results. As a result, the system may encourage users to purchase insurance policies from the insurance providers that are rated as legitimate because the users may be confident that the insurance policies will be accessible to retrieve and/or modify from the database even if the sensitive information about the purchaser is unavailable. Moreover, insurance providers will be encouraged to provide accurate insurance policy information for the database and obtain legitimate status.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description and shown in the accompanying drawings shall be interpreted as illustrative and not in a limiting sense. Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A verification system for generating legitimacy reports and customizing policies, the system comprising:
a database including a plurality of policies, wherein the plurality of policies include assigned policies that have been assigned to policyholders and offered policies that are available for purchase, wherein the policies are provided by a plurality of providers;
a user interface configured to receive a user-defined first search request, a user-defined second search request, and verification information from a user;
a processor configured to:
determine if a list of policies provided by each provider meets at least one requirement that must be completed by the providers to indicate that the list of policies is thorough and accurate, wherein the at least one requirement includes an accessibility of the assigned policies provided by each provider;
generate a legitimacy status for each provider based on the accessibility of the assigned policies provided by the provider;
provide the legitimacy statuses to the providers to incentivize the providers to accurately publish the assigned policies;
generate first search results from the database based on the first search request, wherein the first search results include at least one offered policy provided by at least one of the providers;
generate a grade for each provider based on at least one of a financial standing of the provider, an accreditation of the provider, and a customer rating of the provider;
generate a legitimacy report for the at least one of the providers, wherein the legitimacy report includes the legitimacy status of the at least one of the providers and the grade for the at least one of the providers; and
generate second search results based on the second search request, wherein the second search results include at least one assigned policy; and
a display device configured to display the first search results, the second search results, and the legitimacy report, wherein the legitimacy report is associated with the first search results,
wherein the user interface is configured to:
identify the user as an authorized person for the at least one assigned policy based on the verification information received from the user; and
provide a menu of options for the at least one assigned policies at the display device if the user is identified as an authorized person, wherein the menu of options includes at least one of:
viewing, at the display device, the assigned policy of the plurality of policies;
modifying at least one parameter of the assigned policy; and
generating a claim for benefits from the assigned policy; and
receive a user-selected option from the menu of options,
wherein the processor is configured to, based on the user-selected option:
display the assigned policy on the display device;
modify the at least one parameter of the assigned policy;
notify the provider of a death of the person associated with the at least one assigned policy; or
generate a claim for benefits for the assigned policy.

2. The system of claim 1, further comprising a filter configured to:
sort the first search results based on the legitimacy status of the providers; and
highlight offered policies provided by providers that have accurately published the assigned policies.

3. The system of claim 1, wherein the verification information includes a legal relationship with a policyholder.

4. The system of claim 1, wherein the legitimacy report includes the legitimacy status of the provider and at least one of ability to modify the policies, available options for the policies, the financial standing of the provider, an accreditation of the provider, a customer rating of the provider, and information provided by the provider for each policy.

5. The system of claim 1, wherein the second search request includes identification information for a policy holder, the identification information including one of a name, a social security number, a death certificate number, and a date of birth.

6. The system of claim 1, wherein the second search results include a plurality of assigned policies from a plurality of providers.

7. A computer system comprising at least one processor coupled to a memory, said memory configured to store instructions that, when executed by the at least one processor, cause the at least one processor to:
access a database including a plurality of policies, wherein the plurality of policies include assigned policies that have been assigned to policyholders and offered policies that are available for purchase, wherein the policies are provided by a plurality of providers;
determine if a list of policies provided by each provider meets at least one requirement that must be completed by the providers to indicate that the list of policies is thorough and accurate, wherein the at least one requirement includes an accessibility of the assigned policies provided by each provider;
generate a legitimacy status for each provider based on the accessibility of the assigned policies provided by the provider;
provide the legitimacy statuses to the providers to incentivize the providers to accurately publish the assigned policies;
receive a user-defined first search request for at least one offered policy;
generate first search results from the database based on the first search request, wherein the first search results are displayed on a display device and include at least one offered policy provided by at least one of the providers;
generate a grade for each provider based on at least one of a financial standing of the provider, an accreditation of the provider, and a customer rating of the provider;
generate a legitimacy report for at least one of the providers, wherein the legitimacy report is associated with the search results and includes:
at least one provider of the plurality of providers;
a legitimacy status for each provider based on the accessibility of the assigned policies provided by the provider, wherein the legitimacy status is based on at least one requirement that must be completed by the providers to indicate that a list of policies is thorough and accurate, wherein the at least one requirement includes an accessibility of the assigned policies provided by each provider, and wherein the legitimacy statuses are provided to the providers to incentivize the providers to accurately publish the assigned policies; and
a grade for each provider based on at least one of a financial standing of the provider, an accreditation of the provider, and a customer rating of the provider,
receive a user-defined second search request for at least one assigned policy; and
generate second search results from the database based on the second search request, wherein the second search results are displayed on the display device and include at least one assigned policy.

8. The system of claim 7, wherein the memory is configured to store instructions that, when executed by the at least one processor, cause the at least one processor to:
generate a menu of options for each policy, wherein the menu includes at least one of:
viewing, at the display device, the policy;
modifying, by the computer system, at least one parameter of the policy; and
generating, by the computer system, a claim for benefits from the policy; and
process a user-selected option from the menu of options.

9. The system of claim 7 further comprising a user interface configured to receive verification information from the user, wherein the verification information includes a legal relationship with a policyholder.

10. The system of claim 9 further comprising a filter to allow the user to filter the search results based on the legitimacy status of the providers.

11. The system of claim 8, wherein the memory is configured to store instructions that, when executed by the at least one processor, cause the at least one processor to highlight providers based on the legitimacy status.

12. A user interface for generating legitimacy reports and customizing policies, the system, said user interface comprising:
an input device configured to receive a user-defined first search request, a user-defined second search request, and verification information from a user, wherein the user interface is configured to access a database including a plurality of policies based on the user-defined first search request or the user-defined second search request, wherein the plurality of policies include assigned policies that have been assigned to policyholders and offered policies that are available for purchase, wherein the policies are provided by a plurality of providers;
a display device configured to display first search results based on the user-defined first search request, second search results based on the user-defined second search request, and a legitimacy report for at least one provider, the first search results including at least one offered policy, wherein the legitimacy report is associated with the first search results and includes:
at least one provider of the plurality of providers;
a legitimacy status for each provider based on the accessibility of the assigned policies provided by the provider, wherein the legitimacy status is based on at least one requirement that must be completed by the providers to indicate that a list of policies is thorough and accurate, wherein the at least one requirement includes an accessibility of the assigned policies provided by each provider, and wherein the legitimacy statuses are provided to the providers to incentivize the providers to accurately publish the assigned policies; and
a grade for each provider based on at least one of a financial standing of the provider, an accreditation of the provider, and a customer rating of the provider,
wherein the second search results include at least one assigned policy, wherein the user interface is configured to:
identify the user as an authorized person for the at least one assigned policy based on the verification information received from the user; and
display a menu of options for the at least one assigned policies at the display device if the user is identified as an authorized person, wherein the menu of options includes at least one of:
viewing, at the display device, the assigned policy of the plurality of policies;
modifying at least one parameter of the assigned policy; and
generating a claim for benefits from the assigned policy; and
receive a user-selected option from the menu of options;
and wherein the user interface is configured to, based on the user-selected option:
display the assigned policy on the display device;
modify the at least one parameter of the assigned policy;
notify the provider of a death of the person associated with the at least one assigned policy; and
initiate a claim for benefits for the assigned policy.
